(19) United States
(12) Patent Application Publication
(10) Pub. No.: US 2026/0129519 A1
(43) Pub. Date: May 7, 2026

(54) COMMUNICATION METHOD AND APPARATUS

(71) Applicant: HUAWEI TECHNOLOGIES CO., LTD., Shenzhen (CN)

(72) Inventors: Na Gao, Shanghai (CN); Hao Tang, Shanghai (CN); Ting Wang, Shanghai (CN); Lei Dong, Shanghai (CN); Dongdong Wei, Shenzhen (CN); Jianglei Ma, Ottawa (CA)

(21) Appl. No.: 19/426,659

(22) Filed: Dec. 19, 2025

Related U.S. Application Data
(63) Continuation of application No. PCT/CN2023/103523, filed on Jun. 28, 2023.

(51) Int. Cl. H04W 28/26; H04L 27/26; H04W 72/231; H04W 72/25; H04W 72/51

(52) U.S. Cl. CPC H04W 28/26; H04L 27/2605; H04W 72/231; H04W 72/25; H04W 72/51

(57) ABSTRACT

A communication method and apparatus relating to the field of communication technologies are provided, to resolve problems of high latency in transition from downlink receiving to uplink sending and a waste of resources. The method may include: The communication apparatus determines a first symbol, where the first symbol includes a first interval, and further includes a second interval and/or a third interval, the first interval is used for transition from downlink transmission to uplink transmission and serves as a reserved resource or a guard period, the second interval is used for uplink transmission, and the third interval is used for downlink transmission; and sending first indication information, where the first indication information indicates the first symbol.

### CROSS-REFERENCE TO RELATED APPLICATIONS

This is a continuation of International Patent Application No. PCT/CN2023/103523, filed on Jun. 28, 2023, the disclosure of which is hereby incorporated by reference in its entirety.

### TECHNICAL FIELD

This application relates to the field of communication technologies, and in particular, to a communication method and apparatus.

### BACKGROUND

With development of wireless communication technologies, today's 5th generation mobile communication technology (5G) system are expected to have higher data transmission criteria such as higher throughput, lower latency, enhanced reliability, and greater connections. To meet the foregoing transmission criteria, techniques like enhanced mobile broadband (eMBB), ultra-reliable low-latency communication (URLLC), and massive machine type communication (mMTC) are proposed based on the 5G communication system.

An existing frame structure includes an uplink symbol and a downlink symbol, respectively used for uplink transmission and downlink transmission. In addition, reserved resources like a guard period (GP) are configured between the downlink symbol and the uplink symbol, for a receiving end to perform transition between downlink receiving and uplink sending. For example, one slot may include 14 symbols, in which there are a maximum of two downlink-to-uplink transitions. The two transitions include 2 GP symbols, and overheads of the 2 GP symbols are equal to 1/7 of the slot.

One GP includes round trip time (RTT) between a transmitting end and the receiving end and an uplink-downlink transition latency at the receiving end. In some low latency communication scenarios like URLLC factory scenarios, as the transmitting end device and the receiving end device are not far from each other, RTT is low. However, the reserved resources in the existing frame structure have excessively high overheads, resulting in high latency.

### SUMMARY

Embodiments of this application provide a communication method and apparatus, to resolve problems of high latency in transition from downlink transmission to uplink transmission and a waste of resources.

To achieve the foregoing objective, this application adopts the following technical solutions.

According to a first aspect, a communication method is provided. The method includes: determining a first symbol, where the first symbol includes a first interval and a second interval, or includes a first interval and a third interval, or includes a first interval, a second interval, and a third interval, the first interval is used for transition from downlink transmission to uplink transmission and serves as a reserved resource or a guard period, the second interval is used for uplink transmission, and the third interval is used for downlink transmission; and sending first indication information, where the first indication information indicates the first symbol.

In the foregoing implementation, a new symbol like the first symbol is defined as a partial OFDM symbol. A transmitting end sends the partial OFDM symbol in time domain, and a receiving end recovers a complete frequency-domain signal based on the partial OFDM symbol. A remaining time-domain part may serve as the reserved resource or the guard period to implement an uplink-downlink transition latency, thereby reducing overheads of the GP and lowering the latency.

In an implementation, the first indication information indicates at least one of the following: a starting position of the first interval in the first symbol, duration corresponding to the first interval, a proportion of the duration of the first interval in duration of the first symbol, duration of the second interval in the first symbol, a proportion of the duration of the second interval in the duration of the first symbol, duration of the third interval in the first symbol, or a proportion of the duration of the third interval in the duration of the first symbol.

In an implementation, the first symbol is pre-configured as follows: the starting position of the first interval is a starting position of the first symbol, or an ending position of the first interval is an ending position of the first symbol, or the starting position or the ending position of the first interval is a middle position of the first symbol, or the starting position and/or the ending position of the first interval are/is positions/a position other than the starting position and the ending position at the first symbol.

In an implementation, the first indication information includes a first index value, and the first index value corresponds to a first position and first duration, where the first position indicates a starting position of the first interval in the first symbol, and the first duration indicates duration of the first interval in the first symbol. Alternatively, the first indication information includes a second index value, and the second index value corresponds to second duration and third duration, where the second duration indicates duration of the third interval in the first symbol, and the third duration indicates duration of the second interval in the first symbol.

In an implementation, the first indication information is carried in at least one of the following: a system information block SIB1, a radio resource control RRC signal, downlink control information DCI, sidelink control information SCI, other physical layer signaling, or other higher layer signaling.

In an implementation, the method further includes: receiving capability information of a first apparatus, where the capability information indicates whether the first apparatus supports the first symbol and/or a type of the supported first symbol.

In an implementation, the capability information includes at least one of the following: information about whether the first apparatus supports the first symbol, information about the type of the first symbol supported by the first apparatus, information about a transition period supported by the first apparatus, or information about a capability of the first apparatus for transition from receiving a downlink signal to sending an uplink signal.

According to a second aspect, a communication method is provided. The method includes: receiving first indication information, where the first indication information indicates a first symbol, the first symbol includes a first interval and a second interval, or includes a first interval and a third interval, or includes a first interval, a second interval, and a third interval, the first interval is used for transition from downlink transmission to uplink transmission and serves as a reserved resource or a guard period, the second interval is used for uplink transmission, and the third interval is used for downlink transmission; and determining the first symbol based on the first indication information.

In an implementation, the first indication information indicates at least one of the following: a starting position of the first interval in the first symbol, duration corresponding to the first interval, a proportion of the duration of the first interval in duration of the first symbol, duration of the second interval in the first symbol, a proportion of the duration of the second interval in the duration of the first symbol, duration of the third interval in the first symbol, or a proportion of the duration of the third interval in the duration of the first symbol.

In an implementation, the first symbol is pre-configured as follows: the starting position of the first interval is a starting position of the first symbol, or an ending position of the first interval is an ending position of the first symbol, or the starting position or the ending position of the first interval is a middle position of the first symbol, or the starting position and/or the ending position of the first interval are/is positions/a position other than the starting position and the ending position at the first symbol.

In an implementation, the first indication information includes a first index value, and the first index value corresponds to a first position and first duration, where the first position indicates a starting position of the first interval in the first symbol, and the first duration indicates duration of the first interval in the first symbol. Alternatively, the first indication information includes a second index value, and the second index value corresponds to second duration and third duration, where the second duration indicates duration of the third interval in the first symbol, and the third duration indicates duration of the second interval in the first symbol.

In an implementation, the first indication information is carried in at least one of the following: a system information block SIB1, a radio resource control RRC signal, downlink control information DCI, sidelink control information SCI, other physical layer signaling, or other higher layer signaling.

In an implementation, the method further includes: sending capability information, where the capability information indicates whether a first apparatus supports the first symbol and/or a type of the supported first symbol.

In an implementation, the capability information includes at least one of the following: information about whether the first apparatus supports the first symbol, information about the type of the first symbol supported by the first apparatus, information about a transition period supported by the first apparatus, or information about a capability of the first apparatus for transition from receiving a downlink signal to sending an uplink signal.

According to a third aspect, a communication method is provided. The method includes: determining a first slot format, where the first slot format includes at least one first symbol, the first symbol includes a first interval and a second interval, or includes a first interval and a third interval, or includes a first interval, a second interval, and a third interval, the first interval is used for transition from downlink transmission to uplink transmission and serves as a reserved resource or a guard period, the second interval is used for uplink transmission, and the third interval is used for downlink transmission; and sending second indication information indicating the first slot format.

In the foregoing implementation, by exchanging second indication information, a transmitting end and a receiving end may determine a format of at least one slot including a first symbol, and apply some symbols to specific information transmission, thereby reducing latency overheads of a guard period and improving utilization of communication resources. Further, the transmitting end and the receiving end can flexibly configure and indicate a transmission resource, thereby improving transmission efficiency.

In an implementation, the second indication information indicates position information of the at least one first symbol.

In an implementation, the first symbol is a last symbol of a downlink channel, or the first symbol is a 1^{st} symbol of an uplink channel.

In an implementation, the second indication information indicates a sequence number of the at least one first symbol in the first slot format.

In an implementation, before receiving the second indication information, the method further includes: receiving third indication information, where the third indication information indicates a second slot format, and the second slot format includes at least one of an uplink symbol, a downlink symbol, or a flexible symbol. The second indication information includes a sequence number of at least one symbol in the second slot format, and the sequence number indicates a sequence number of the first symbol in the first slot format.

In an implementation, the second indication information indicates information about the first symbol included in an uplink transmission symbol, a downlink transmission symbol, a flexible symbol, a frame structure, or a mini-slot.

In an implementation, the second indication information is carried in at least one of the following: a system information block SIB1, a radio resource control RRC signal, downlink control information DCI, sidelink control information SCI, a slot format indicator SFI, other physical layer signaling, or other higher layer signaling.

In an implementation, the method further includes: receiving capability information of a first apparatus, where the capability information indicates whether the first apparatus supports the first symbol and/or a type of the supported first symbol.

In an implementation, the capability information includes at least one of the following: information about whether the first apparatus supports the first symbol, information about the type of the first symbol supported by the first apparatus, information about a transition period supported by the first apparatus, or information about a capability of the first apparatus for transition from receiving a downlink signal to sending an uplink signal.

According to a fourth aspect, a communication method is provided. The method includes: receiving second indication information, where the second indication information is used for determining a first slot format, the first slot format includes at least one first symbol, the first symbol includes a first interval and a second interval, or includes a first interval and a third interval, or includes a first interval, a second interval, and a third interval, the first interval is used for transition from downlink transmission to uplink transmission and serves as a reserved resource or a guard period, the second interval is used for uplink transmission, and the third interval is used for downlink transmission; and determining the first slot format based on the second indication information.

In an implementation, the second indication information indicates position information of the at least one first symbol.

In an implementation, the first symbol is a last symbol of a downlink channel, or the first symbol is a 1^{st} symbol of an uplink channel.

In an implementation, the second indication information indicates a sequence number of the at least one first symbol in the first slot format.

In an implementation, before receiving the second indication information, the method further includes: receiving third indication information, where the third indication information indicates a second slot format, and the second slot format includes at least one of an uplink symbol, a downlink symbol, or a flexible symbol. The second indication information includes a sequence number of at least one symbol in the second slot format, and the sequence number indicates a sequence number of the first symbol in the first slot format.

In an implementation, the second indication information indicates information about the first symbol included in an uplink transmission symbol, a downlink transmission symbol, a flexible symbol, a frame structure, or a mini-slot.

In an implementation, the second indication information is carried in at least one of the following: a system information block SIB1, a radio resource control RRC signal, downlink control information DCI, sidelink control information SCI, a slot format indicator SFI, other physical layer signaling, or other higher layer signaling.

In an implementation, the method further includes: sending capability information of a first apparatus, where the capability information indicates whether the first apparatus supports the first symbol and/or a type of the supported first symbol.

In an implementation, the capability information includes at least one of the following: information about whether the first apparatus supports the first symbol, information about the type of the first symbol supported by the first apparatus, information about a transition period supported by the first apparatus, or information about a capability of the first apparatus for transition from receiving a downlink signal to sending an uplink signal.

According to a fifth aspect, a communication apparatus is provided. The apparatus includes: a processing module, configured to determine a first symbol, where the first symbol includes a first interval and a second interval, or includes a first interval and a third interval, or includes a first interval, a second interval, and a third interval, the first interval is used for transition from downlink transmission to uplink transmission and serves as a reserved resource or a guard period, the second interval is used for uplink transmission, and the third interval is used for downlink transmission; and a communication module, configured to send first indication information, where the first indication information indicates the first symbol.

In an implementation, the first indication information indicates at least one of the following: a starting position of the first interval in the first symbol, duration corresponding to the first interval, a proportion of the duration of the first interval in duration of the first symbol, duration of the second interval in the first symbol, a proportion of the duration of the second interval in the duration of the first symbol, duration of the third interval in the first symbol, or a proportion of the duration of the third interval in the duration of the first symbol.

In an implementation, the first symbol is pre-configured as follows: the starting position of the first interval is a starting position of the first symbol, or an ending position of the first interval is an ending position of the first symbol, or the starting position or the ending position of the first interval is a middle position of the first symbol, or the starting position and/or the ending position of the first interval are/is positions/a position other than the starting position and the ending position at the first symbol.

In an implementation, the first indication information includes a first index value, and the first index value corresponds to a first position and first duration, where the first position indicates a starting position of the first interval in the first symbol, and the first duration indicates duration of the first interval in the first symbol. Alternatively, the first indication information includes a second index value, and the second index value corresponds to second duration and third duration, where the second duration indicates duration of the third interval in the first symbol, and the third duration indicates duration of the second interval in the first symbol.

In an implementation, the first indication information is carried in at least one of the following: a system information block SIB1, a radio resource control RRC signal, downlink control information DCI, sidelink control information SCI, other physical layer signaling, or other higher layer signaling.

In an implementation, the communication module is further configured to receive capability information of the apparatus, where the capability information indicates whether the apparatus supports the first symbol and/or a type of the supported first symbol.

In an implementation, the capability information includes at least one of the following: information about whether the apparatus supports the first symbol, information about the type of the first symbol supported by the apparatus, information about a transition period supported by the apparatus, or information about a capability of the apparatus for transition from receiving a downlink signal to sending an uplink signal.

According to a sixth aspect, a communication apparatus is provided. The apparatus includes: a communication module, configured to receive first indication information, where the first indication information indicates a first symbol, the first symbol includes a first interval and a second interval, or includes a first interval and a third interval, or includes a first interval, a second interval, and a third interval, the first interval is used for transition from downlink transmission to uplink transmission and serves as a reserved resource or a guard period, the second interval is used for uplink transmission, and the third interval is used for downlink transmission; and a processing module, configured to determine the first symbol based on the first indication information.

In an implementation, the first indication information indicates at least one of the following: a starting position of the first interval in the first symbol, duration corresponding to the first interval, a proportion of the duration of the first interval in duration of the first symbol, duration of the second interval in the first symbol, a proportion of the duration of the second interval in the duration of the first symbol, duration of the third interval in the first symbol, or a proportion of the duration of the third interval in the duration of the first symbol.

In an implementation, the first symbol is pre-configured as follows: the starting position of the first interval is a starting position of the first symbol, or an ending position of the first interval is an ending position of the first symbol, or the starting position or the ending position of the first interval is a middle position of the first symbol, or the starting position and/or the ending position of the first interval are/is positions/a position other than the starting position and the ending position at the first symbol.

In an implementation, the first indication information includes a first index value, and the first index value corresponds to a first position and first duration, where the first position indicates a starting position of the first interval in the first symbol, and the first duration indicates duration of the first interval in the first symbol. Alternatively, the first indication information includes a second index value, and the second index value corresponds to second duration and third duration, where the second duration indicates duration of the third interval in the first symbol, and the third duration indicates duration of the second interval in the first symbol.

In an implementation, the first indication information is carried in at least one of the following: a system information block SIB1, a radio resource control RRC signal, downlink control information DCI, sidelink control information SCI, other physical layer signaling, or other higher layer signaling.

In an implementation, the communication module is further configured to send capability information of the apparatus, where the capability information indicates whether the apparatus supports the first symbol and/or a type of the supported first symbol.

In an implementation, the capability information includes at least one of the following: information about whether the apparatus supports the first symbol, information about the type of the first symbol supported by the apparatus, information about a transition period supported by the apparatus, or information about a capability of the apparatus for transition from receiving a downlink signal to sending an uplink signal.

According to a seventh aspect, a communication apparatus is provided. The apparatus includes: a processing module, configured to determine a first slot format, where the first slot format includes at least one first symbol, the first symbol includes a first interval and a second interval, or includes a first interval and a third interval, or includes a first interval, a second interval, and a third interval, the first interval is used for transition from downlink transmission to uplink transmission and serves as a reserved resource or a guard period, the second interval is used for uplink transmission, and the third interval is used for downlink transmission; and a communication module, configured to send second indication information indicating the first slot format.

In an implementation, the second indication information indicates position information of the at least one first symbol.

In an implementation, the first symbol is a last symbol of a downlink channel, or the first symbol is a 1^{st} symbol of an uplink channel.

In an implementation, the second indication information indicates a sequence number of the at least one first symbol in the first slot format.

In an implementation, the communication module is further configured to: receive third indication information, where the third indication information indicates a second slot format, the second slot format includes at least one of an uplink symbol, a downlink symbol, or a flexible symbol, the second indication information includes a sequence number of at least one symbol in the second slot format, and the sequence number indicates a sequence number of the first symbol in the first slot format.

In an implementation, the second indication information indicates information about the first symbol included in an uplink transmission symbol, a downlink transmission symbol, a flexible symbol, a frame structure, or a mini-slot.

In an implementation, the second indication information is carried in at least one of the following: a system information block SIB1, a radio resource control RRC signal, downlink control information DCI, sidelink control information SCI, a slot format indicator SFI, other physical layer signaling, or other higher layer signaling.

In an implementation, the communication module is further configured to receive or send capability information of the apparatus, where the capability information indicates whether the apparatus supports the first symbol and/or a type of the supported first symbol.

In an implementation, the capability information includes at least one of the following: information about whether the apparatus supports the first symbol, information about the type of the first symbol supported by the apparatus, information about a transition period supported by the apparatus, or information about a capability of the apparatus for transition from receiving a downlink signal to sending an uplink signal.

According to an eighth aspect, a communication apparatus is provided. The apparatus includes: a communication module, configured to receive second indication information, where the second indication information indicates a first slot format, the first slot format includes at least one first symbol, the first symbol includes a first interval and a second interval, or includes a first interval and a third interval, or includes a first interval, a second interval, and a third interval, the first interval is used for transition from downlink transmission to uplink transmission and serves as a reserved resource or a guard period, the second interval is used for uplink transmission, and the third interval is used for downlink transmission; and a processing module, configured to determine the first slot format based on the second indication information.

In an implementation, the second indication information indicates position information of the at least one first symbol.

In an implementation, the first symbol is a last symbol of a downlink channel, or the first symbol is a 1^{st} symbol of an uplink channel.

In an implementation, the second indication information indicates a sequence number of the at least one first symbol in the first slot format.

In an implementation, the communication module is further configured to: send third indication information, where the third indication information indicates a second slot format, the second slot format includes at least one of an uplink symbol, a downlink symbol, or a flexible symbol, the second indication information includes a sequence number of at least one symbol in the second slot format, and the sequence number indicates a sequence number of the first symbol in the first slot format.

In an implementation, the second indication information indicates information about the first symbol included in an uplink transmission symbol, a downlink transmission symbol, a flexible symbol, a frame structure, or a mini-slot.

In an implementation, the second indication information is carried in at least one of the following: a system information block SIB1, a radio resource control RRC signal, downlink control information DCI, sidelink control information SCI, a slot format indicator SFI, other physical layer signaling, or other higher layer signaling.

In an implementation, the communication module is further configured to receive or send capability information of the apparatus, where the capability information indicates whether the apparatus supports the first symbol and/or a type of the supported first symbol.

In an implementation, the capability information includes at least one of the following: information about whether the apparatus supports the first symbol, information about the type of the first symbol supported by the apparatus, information about a transition period supported by the apparatus, or information about a capability of the apparatus for transition from receiving a downlink signal to sending an uplink signal.

According to a ninth aspect, a communication apparatus is provided, including: one or more processors and one or more memories. The one or more memories are coupled to the one or more processors, the one or more memories are configured to store computer program code, and the computer program code includes computer instructions. When the one or more processors execute the computer instructions, the communication apparatus is caused to perform the method according to any one of the first aspect to the fourth aspect.

According to a tenth aspect, a non-transitory computer-readable storage medium is provided. The non-transitory computer-readable storage medium stores computer-executable instructions. When the computer-executable instructions are invoked by a computer, the computer is caused to perform the method according to any one of the first aspect to the fourth aspect.

According to an eleventh aspect, a computer program product is provided. When the computer program product runs on a computer, the computer is caused to perform the method according to any one of the first aspect to the fourth aspect.

According to a twelfth aspect, a communication system is provided. The communication system may include the communication apparatus according to any one of the fifth aspect and the sixth aspect, or the communication system may include the communication apparatus according to any one of the seventh aspect and the eighth aspect.

According to a thirteenth aspect, a chip is provided. The chip is coupled to a memory, and is configured to read and execute program instructions stored in the memory, to implement the method according to any one of the first aspect to the fourth aspect.

It may be understood that any communication apparatus, non-transitory computer-readable storage medium, computer program product, communication system, or chip according to the fifth aspect to the twelfth aspect may be implemented by using the corresponding method provided above. Therefore, for beneficial effects that can be achieved by the apparatus, non-transitory computer-readable storage medium, computer program product, communication system, or chip, refer to beneficial effects in the corresponding method provided above. Details are not described herein again.

### BRIEF DESCRIPTION OF DRAWINGS

FIG. 1 to FIG. 5 are a diagram 1 to a diagram 5 of architectures of communication systems according to embodiments of this application;

FIG. 6 is a diagram of a structure of a communication apparatus according to an embodiment of this application;

FIG. 7 is a diagram of a guard period according to an embodiment of this application;

FIG. 8 is a diagram of a slot format according to an embodiment of this application;

FIG. 9 is a diagram of a slot format according to an embodiment of this application;

FIG. 10 is a diagram of compressive sensing processing according to an embodiment of this application;

FIG. 11 is a diagram of a communication method according to an embodiment of this application;

FIG. 12 is a diagram of different types of first symbols according to an embodiment of this application;

FIG. 13 is a diagram of a composition of a first symbol according to an embodiment of this application;

FIG. 14 is a schematic flowchart of a communication method according to an embodiment of this application;

FIG. 15 is a diagram of a first slot format according to an embodiment of this application;

FIG. 16 is a diagram of another first slot format according to an embodiment of this application;

FIG. 17 is a diagram of another first slot format according to an embodiment of this application;

FIG. 18 is a diagram of another first slot format according to an embodiment of this application;

FIG. 19 is a diagram of a mini-slot format according to an embodiment of this application; and

FIG. 20 is a diagram of a structure of a communication apparatus according to an embodiment of this application.

### DESCRIPTION OF EMBODIMENTS

The following describes the technical solutions in embodiments of this application with reference to the accompanying drawings in embodiments of this application. It is clear that the described embodiments are merely some rather than all of embodiments of this application.

The terms “first” and “second” mentioned below are merely intended for a purpose of description, and shall not be understood as an indication or implication of relative importance or implicit indication of the quantity of indicated technical features. Therefore, a feature limited by “first”, “second”, or the like may explicitly or implicitly include one or more features.

In addition, in this application, orientation terms such as “up”, “down”, “left”, “right”, “horizontal”, and “vertical” are defined relative to an orientation in which components are schematically placed in the accompanying drawings. It should be understood that, these directional terms are relative concepts that are used for relative description and clarification, and may vary accordingly based on changes of the orientation in which the components are placed in the accompanying drawings.

In this application, unless otherwise clearly specified and limited, a term “connection” should be understood in a broad sense. For example, “connection” may be a fixed connection, a detachable connection, or an integrated connection, or may be a direct connection or an indirect connection implemented through an intermediate medium.

First, implementation scenarios of embodiments of this application is described with reference to the accompanying drawings.

A method provided in embodiments of this application may be applied to various communication systems, including but not limited to: a non-terrestrial networks (NTN) communication system, a narrow band-Internet of Things (NB-IoT) system, a global system for mobile communication (GSM), an enhanced data rate for GSM evolution system (EDGE), a wideband code division multiple access (WCDMA) system, a code division multiple access (CDMA2000) 2000 system, a time division-synchronous code division multiple access (TD-SCDMA) system, a long term evolution (LTE) system, a 5G mobile communication system, the three major application scenarios of a next-generation system such as a 6G mobile communication system, including enhanced mobile broadband (eMBB), ultra-reliable low-latency communication (URLLC), and enhanced machine-type communication (eMTC), and the like.

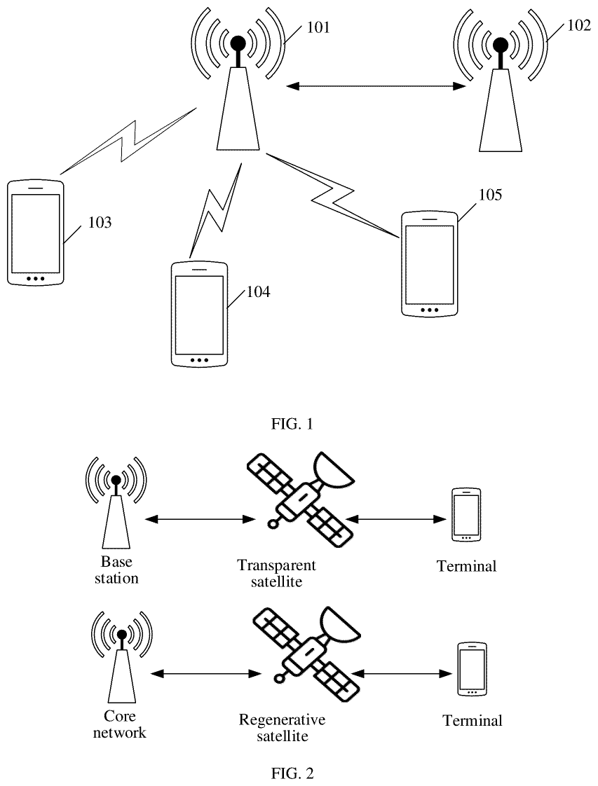

The following describes a communication scenario of embodiments of this application only by using communication systems shown in FIG. 1 to FIG. 5.

FIG. 1 is a diagram of an architecture of a communication system according to an embodiment of this application. In FIG. 1, the communication system may include at least one network device and/or at least one terminal device. For example, the communication system may include a network device 101 and a network device 102, or the communication system includes a network device 101 and a terminal device 103, or the communication system may include a terminal device 104 and a terminal device 105.

In FIG. 1, the network device may provide a wireless access service for the terminal device. Each network device corresponds to one service coverage area. A terminal device that enters the area may communicate with the network device via a Uu interface, to receive a wireless access service provided by the network device. The terminal device and the network device may communicate with each other via a Uu interface link. Uu interface links may be classified into uplink (UL) and downlink (DL) based on directions of data transmission on the Uu interface links. Data sent from the terminal device to the network device may be transmitted on UL, and data transmitted from the network device to the terminal device may be transmitted on DL. For example, in FIG. 1, the terminal device 103 is located in a coverage area of the network device 101, the network device 101 may send data to the terminal device 103 via DL, and the terminal device 103 may send data to the network device 101 via UL.

The terminal device and another terminal device may communicate with each other via a direct communication link. The direct communication link may be referred to as a side link or a sidelink (SL). For example, the direct communication link is sidelink. In FIG. 1, the terminal device 103 and the terminal device 104 may communicate with each other via sidelink. In FIG. 1, the terminal device 104 and the terminal device 105 may communicate with each other via sidelink.

The network device in FIG. 1, such as the network device 101 or the network device 102, may be a transmission reception point (TRP), a base station, a relay station, an access point, or the like. The network device 101 or 102 may be a network device in a 5G communication system or a network device in a future evolved network, or may be a base transceiver station (BTS) in a global system for mobile communication (GSM) or code division multiple access (CDMA) network, or may be an NB (NodeB) in wideband code division multiple access (WCDMA), or may be an eNB or an eNodeB (evolved NodeB) in long term evolution (LTE). The network device 101 or the network device 102 may alternatively be a radio controller in a cloud radio access network (CRAN) scenario.

The terminal device in FIG. 1, such as the terminal devices 103, the terminal device 104, or the terminal device 105, may be a device that has a wireless transceiver function and can provide communication services for users. The terminal device 103, the terminal device 104, or the terminal device 105 may be a device in a V2X system, a device in a D2D system, a device in a machine type communication (MTC) system, or the like. For example, the terminal device 103, the terminal device 104, the terminal device 105, or a terminal device 106 may refer to an industrial robot, an industrial automation device, user equipment (UE), an access terminal, a subscriber unit, a subscriber station, a mobile station, a remote station, a remote terminal, a mobile device, a user terminal, a terminal, a wireless terminal device, a user agent, or a user apparatus. For example, the terminal device 103, the terminal device 104, the terminal device 105, or the terminal device 106 may be a cellular phone, a cordless phone, a session initiation protocol (SIP) phone, a wireless local loop (WLL) station, a personal digital assistant (PDA), a handheld device with a wireless communication function, a computing device, or another processing device connected to a wireless modem, a vehicle-mounted device, a wearable device, a terminal device in a 5G network or a network after 5G, or a terminal device in a future evolved network. This is not limited in this application. The terminal device in this application may alternatively be a vehicle module, a vehicle-mounted assembly, a vehicle-mounted component, a vehicle-mounted chip, or a vehicle-mounted unit that is disposed in a vehicle as one or more components or units. The vehicle may implement a method in this application by using the vehicle-mounted module, the vehicle-mounted assembly, the vehicle-mounted component, the vehicle-mounted chip, or the vehicle-mounted unit that is disposed in the vehicle.

In an implementation, the network device may be an air network device in an NTN communication system, or may be a non-terrestrial base station or a non-terrestrial device, such as an unmanned aerial vehicle, a hot-air balloon, a low-orbit satellite, a medium-orbit satellite, or an elevated-orbit satellite. The method provided in embodiments of this application may be applied to a communication system shown in FIG. 2. The communication system may include an air network device such as a satellite. The communication system may further include at least one terminal device such as a terminal device shown in FIG. 2.

The satellite may work either in a transparent mode or a regenerative mode. For the satellite working in the transparent mode, the satellite may serve as a relay forwarding device to forward a signal of a network device or a terminal, and may be used for performing enhanced processing on terrestrial network coverage. The satellite may have functions of radio frequency filtering, frequency conversion, and amplification. As shown in FIG. 2, transparent forwarding may be performed between a terminal and a base station through the transparent satellite.

For the satellite working in the regenerative mode, the satellite has a signal processing capability. It may be understood that the satellite has a processing function of a base station, and can send a signal to another network device or a terminal device, so as to provide a communication service for the terminal device. As shown in FIG. 2, a terminal establishes wireless communication with the regenerative satellite via a Uu interface, to implement communication with a core network.

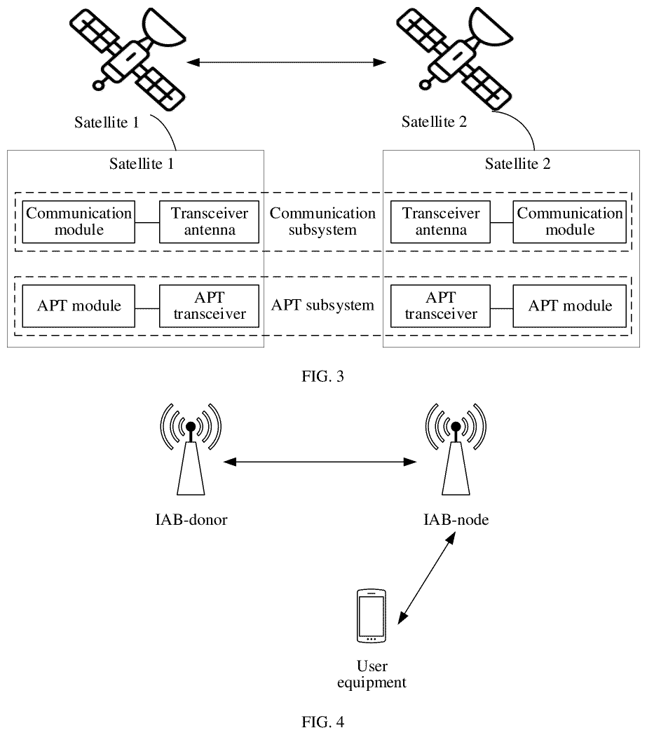

In addition, the method provided in embodiments of this application may be applied to an inter-satellite link (ISL) communication system between satellites shown in FIG. 3. The communication system may include Satellite 1 and Satellite 2, and Satellite 1 and Satellite 2 communicate with each other via the inter-satellite link. The satellite includes two parts: an acquisition, pointing and tracking (APT) subsystem and a communication subsystem, as shown in FIG. 3.

The communication subsystem is responsible for inter-satellite information transmission, and is a main body of the inter-satellite communication system. The APT subsystem is responsible for acquisition, pointing, and tracking between the satellites. Acquisition refers to determining a direction of arrival of an incident signal, pointing refers to adjusting a transmission wave toward a receiving direction, and tracking refers to continuously adjusting pointing and acquisition throughout a communication process. To reduce the impact of attenuation and interference on a channel as much as possible and ensure high confidentiality and transmission rate, the APT can be adjusted in real time to continuously adapt to changes. An existing APT subsystem and an existing communication subsystem are independent systems. The APT subsystem may be an optical system, optical alignment is difficult, and pointing is mechanically adjusted. The communication subsystem may be an optical communication system or a system operating in a microwave frequency band, typically employing a single high-gain antenna.

The method provided in embodiments of this application may be applied to an integrated access and backhaul (IAB) network shown in FIG. 4. The IAB network refers to a transmission network that integrates information access and backhaul between a terminal, a core network, and a user service end (such as a server). For a backhaul link and an access link, the IAB network can implement integration of access and backhaul. As shown in FIG. 4, the IAB network may include an IAB-donor, an IAB-node, and user equipment. A link between the IAB-donor and the IAB-node is the backhaul link, and a link between the user equipment and the IAB-node is the access link.

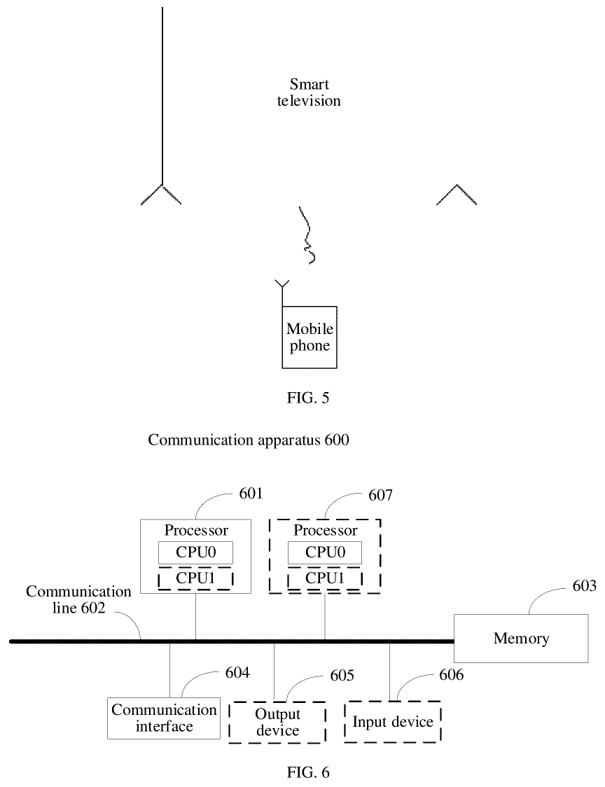

For example, the method provided in embodiments of this application may be applied to a sidelink communication scenario between terminals. Typical application scenarios include scenarios such as wireless screen mirroring, a virtual reality (VR) game, or data encoding and decoding of an application in a mobile phone. FIG. 5 is a diagram of wireless screen mirroring of a mobile phone, which involves a smart television and a smartphone that implement screen mirroring playback via a wireless signal.

It should be noted that the communication systems shown in FIG. 1 to FIG. 5 are merely used as examples, and are not intended to limit the technical solutions of this application. A person skilled in the art should understand that in example implementation process, the communication system may further include another device, and further, a quantity of network devices and a quantity of terminal devices may be determined based on a specific criterion. In addition, the network elements in the drawings may further be connected via other interfaces. This is not limited.

Optionally, the network elements in the drawings of embodiments of this application, such as the network device or the terminal device, may be one functional module in one apparatus. It may be understood that the functional module may be an element in a hardware device, such as a communication chip or a communication component in a terminal device or a network device, or may be a software functional module running on hardware, or a virtualized function instantiated on a platform (such as a cloud platform).

For example, the network elements in FIG. 1 to FIG. 5 may be implemented using a communication apparatus 600 in FIG. 6. FIG. 6 is a diagram of a hardware structure of a communication apparatus to which embodiments of this application are applicable. The communication apparatus 600 may include at least one processor 601, a communication line 602, a memory 603, and at least one communication interface 604.

The processor 601 may be one general-purpose central processing unit (CPU), microprocessor, or application-specific integrated circuit (ASIC), or one or more integrated circuits configured to control execution of programs for implementing the solutions of this application.

The communication line 602 may include a path, such as a bus, for transferring information between the foregoing components.

The communication interface 604 is configured to communicate with another device or a communication network through any apparatus such as a transceiver, and is, for example, an Ethernet interface, a radio access network (RAN) interface, or a wireless local area network (WLAN) interface.

The memory 603 may be a read-only memory (ROM) or another type of static storage device that can store static information and instructions, or a random access memory (RAM) or another type of dynamic storage device that can store information and instructions, or may be an electrically erasable programmable read-only memory (EEPROM), a compact disc read-only memory (CD-ROM) or another optical disk storage, an optical disc storage (including a compact disc, a laser disc, an optical disc, a digital versatile disc, a Blu-ray disc, or the like), a disk storage medium or another magnetic storage device, or any other medium that can be used to carry or store expected program code in a form of instructions or a data structure and that can be accessed by a computer, but is not limited thereto. The memory may exist independently, and is connected to the processor via the communication line 602. The memory may alternatively be integrated with the processor. The memory provided in embodiments of this application may be typically non-volatile. The memory 603 is configured to store computer-executable instructions for performing the solutions of this application, and the processor 601 controls execution. The processor 601 is configured to execute the computer-executable instructions stored in the memory 603, to implement the method provided in embodiments of this application.

Optionally, the computer-executable instructions in embodiments of this application may alternatively be referred to as application code. This is not specifically limited in embodiments of this application.

As an embodiment, the processor 601 may include one or more CPUs, such as CPU0 and CPU1 in FIG. 6.

As an embodiment, the communication apparatus 600 may include a plurality of processors, such as the processor 601 and a processor 607 in FIG. 6. Each of the processors may be one single-core processor, or may be one multi-core processor. The processor herein may refer to one or more devices, circuits, and/or processing cores configured to process data (such as computer program instructions).

As an embodiment, the communication apparatus 600 may further include an output device 605 and an input device 606. The output device 605 communicates with the processor 601, and may display information in a plurality of manners. For example, the output device 605 may be a liquid crystal display (LCD), a light emitting diode (LED) display device, a cathode ray tube (CRT) display device, a projector, or the like. The input device 606 communicates with the processor 601, and may receive an input of a user in a plurality of manners. For example, the input device 606 may be a mouse, a keyboard, a touchscreen device, a sensor device, or the like.

The communication apparatus 600 may be a desktop computer, a portable computer, a network server, a personal digital assistant (PDA), a mobile phone, a tablet computer, a wireless terminal device, an embedded device, or a device having a structure similar to that in FIG. 6. A type of the communication apparatus 600 is not limited in embodiments of this application.

In radio resources, a minimum resource granularity in time domain may be one orthogonal frequency division multiplexing (OFDM) symbol. The OFDM symbol may be referred to as an OS for short. Currently, OFDM symbols may include the following three types.

Uplink symbol: It is denoted as the letter U and is used for uplink transmission. A carried signal may be referred to as an uplink signal.

Downlink symbol: It is denoted as the letter D and is used for downlink transmission. A carried signal may be referred to as a downlink signal.

Flexible symbol: It is denoted as the letter F, and may serve as a reserved resource for uplink transmission or downlink transmission. In addition, the flexible symbol may further serve as a guard period (GP) for implementing transition between uplink and downlink transmission.

A length of one OFDM symbol may include a length of a cyclic prefix (CP) and a length of a wanted symbol. To meet different latency criteria, CPs may be classified into normal CPs and extended CPs. For example, in the case of 60 kHz SCS, one slot includes 14 symbols for normal CPs, while one slot includes 12 symbols for extended CPs. This may be used in communication scenarios with a high transmission latency.

In existing protocols, for different subcarrier spacings (SCS), corresponding CP lengths and symbol duration, which may alternatively be referred to as wanted symbol lengths, are set; and a corresponding quantity of symbols in each slot is set. For details, refer to Table 1.

TABLE 1

| | Subcarrier spacing SCS (kHz) | | | | |
|---|---|---|---|---|---|
| | 15 | 30 | 60 | 120 | 240 |
| Symbol duration (μs) | 66.7 | 33.3 | 16.7 | 8.33 | 4.17 |
| CP duration (μs) | 4.7 | 2.3 | 1.2 (normal CP) | 0.59 | 0.29 |
| | | | 4.13 (extended CP) | | |
| Max. nominal | 50 | 100 | 100 (electromagnetic | 400 | 400 |
| system BW (MHz) | | | wave with a frequency | | |
| | | | lower than 6 GHz), | | |
| | | | 200 (millimeter wave) | | |
| FFT size (max.) | 4096 | 4096 | 4096 | 4096 | 4096 |
| Quantity of symbols | 14 | 14 | 14 (normal CP) | 14 | 14 |
| within each slot | | | 12 (extended CP) | | |
| Quantity of slots | 1 | 2 | 4 | 8 | 16 |
| within each | | | | | |
| subframe | | | | | |
| Quantity of slots | 10 | 20 | 40 | 80 | 160 |
| within each radio | | | | | |
| frame | | | | | |

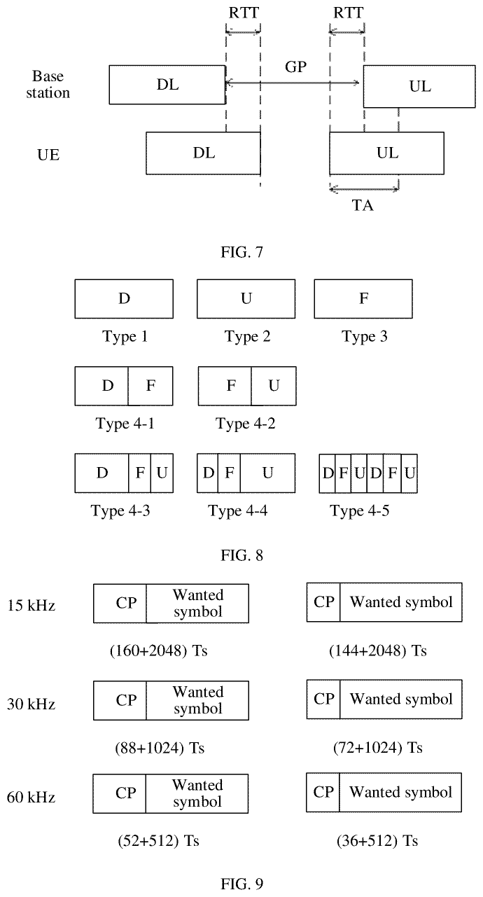

For example, as shown in FIG. 7, a base station sends a DL signal to UE, and the UE sends an uplink signal to the base station. For the UE, one GP between the DL signal and the UL signal may include two parts: a latency in transition from downlink transmission to uplink transmission and a length that is twice round trip time (RTT).

Each slot may be freely composed of the foregoing three types of symbols, to form a plurality of slot formats. Based on the foregoing symbol types, slot formats agreed on in current protocols may include the following types:
Type 1: A slot includes only a symbol D, so that the slot is used for transmitting only a downlink signal, and is a downlink slot, which is also referred to as a DL-only slot. For example, the slot is of type 1 in FIG. 8.
Type 2: A slot includes only a symbol U, so that the slot is used for transmitting only an uplink signal, and is an uplink slot, which is also referred to as a UL-only slot. For example, the slot is of type 2 in FIG. 8.
Type 3: A slot includes only a symbol F, so that the slot may be used for transmitting an uplink signal and/or a downlink signal, and is also referred to as a flexible-only slot. For example, the slot is of type 3 in FIG. 8.
Type 4: One slot at least includes one symbol D or symbol U, and the slot further includes a symbol F. For example, the slot is of type 4-1 to type 4-5 in FIG. 8.

In the communication field, two time units Tc and Ts are defined. The time unit T_{c}=1/(Δfₘₐₓ·N_{f}), where Δfₘₐₓ=480. 103 Hz, and N_{f}=4096·κ=Tₛ/T_{c}=64, and the time unit Tₛ=1/(Δf_{ref}·N_{f,ref}), where Δf_{ref}=15. 103 Hz, and No. ref=2048. FIG. 9 is a diagram of frame structures and slot formats in a unit of Ts using SCSs of 15 kHz, 30 kHz, and 45 kHz as examples. For example, as shown in FIG. 9, for the SCS that is 15 kHz, there are two corresponding slot formats. A length of a wanted symbol is 2048 Ts, a normal CP is 144 Ts, and a corresponding slot is (144+2048) Ts; and an extended CP is 160 Ts, and a corresponding slot is (160+2048) Ts. For the SCS that is 30 kHz, a length of a corresponding wanted symbol is 1024 Ts, a normal CP is 72 Ts, and a corresponding slot is (72+1024) Ts; and an extended CP is 88 Ts, and a corresponding slot is (88+1024) Ts. For the SCS that is 60 kHz, a length of a corresponding wanted symbol is 512 Ts, a normal CP is 36 Ts, a corresponding slot is (36+512) Ts; and an extended CP is 52 Ts, and a corresponding slot is (52+512) Ts.

With reference to FIG. 7, in an existing slot format, one slot may include a maximum of two GP symbols, and overheads of the two GP symbols are equal to 1/7 of the slot. In a communication scenario with a low latency criterion, such as a factory scenario, a distance between a receiving end device and a transmitting end device is short. Therefore, RTT is low. However, overheads of a guard period in an existing frame structure are excessively high, resulting in a high latency.

To resolve the foregoing problem, this application provides a communication method. A new symbol, such as a partial OFDM symbol, is defined. Based on processing such as a “compressive sensing algorithm” or “frequency-domain zero-padding”, a transmitting end sends the partial OFDM symbol in time domain, and a receiving end recovers a complete frequency-domain signal based on the partial OFDM symbol. A remaining time-domain part may serve as a reserved resource or a guard period to implement an uplink-downlink transition latency, thereby reducing overheads of the GP and lowering the latency.

According to the existing classical Nyquist sampling theorem, to recover an original signal from a sampled signal without distortion, a Nyquist sampling frequency needs to be greater than twice a highest frequency of the original signal. The premise of the sampling theorem is to perform equal-space sampling.

The compressive sensing algorithm is also referred to as compressive sampling or sparse sampling. By developing a sparse feature of a signal, a discrete sample of the signal may be obtained through random sampling for a sampling rate that is far less than a Nyquist sampling rate, and then the original signal is recovered by using a non-linear reconstruction algorithm. In other words, the compressive sensing algorithm can achieve an effect of full sampling by using a very small quantity of sampling points. Conditions for the compressive sensing algorithm include: (1) A signal is sparse in specific transform domain. For example, the signal has only a few non-zero values in frequency domain, the signal is sparse; and (2) random sub-sampling is employed.

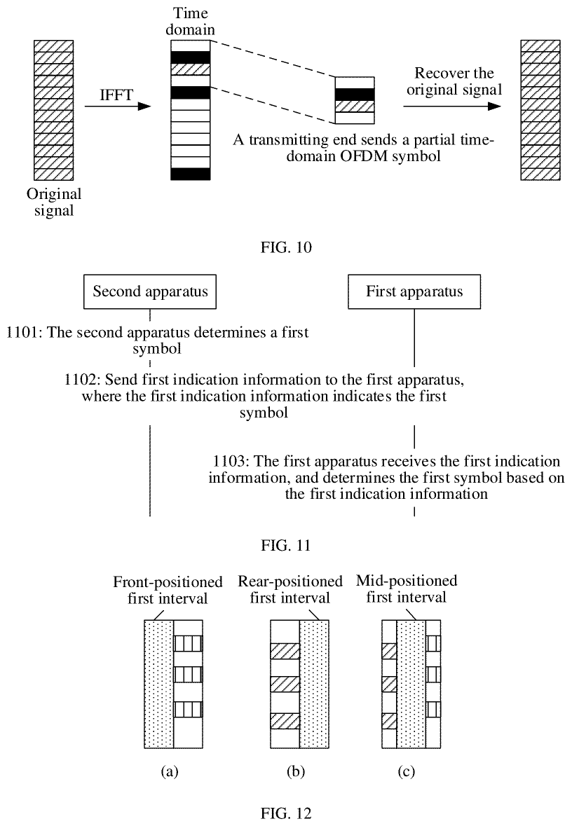

For the compressive sensing algorithm, as shown in FIG. 10, the original signal is sparse in frequency domain, the transmitting end sends the partial time-domain OFDM symbol; and the receiving end receives the partial time-domain OFDM symbol, and may recover the original frequency-domain signal by using a decompressive sensing algorithm.

In addition, frequency-domain zero-padding is a periodicity property of a discrete Fourier transform. Based on such a periodicity property, a part of used time-domain information may be sent/received, so as to recover a frequency-domain signal in advance.

For example, frequency-domain zero-padding is performed on a first frequency-domain signal [a1, a2, a3, a4], for example, 0s are inserted between every two signals, and an obtained second frequency-domain signal may be [a1, 0, a2, 0, a3, 0, a4, 0]. An inverse discrete Fourier transform (IDFT) or an inverse fast Fourier transform (IFFT) is performed on the second frequency-domain signal, to obtain a second time-domain signal of the second frequency-domain signal. It can be seen that the second time-domain signal of the second frequency-domain signal is 2 repetitions of a first time-domain signal of the first frequency-domain signal, and the original frequency-domain signal may be recovered based on a part of the received second time-domain signal, such as ½ of the second time-domain signal.

The following describes in detail the method provided in embodiments of this application with reference to the accompanying drawings. The following embodiments of this application may be applied to any one of the foregoing communication systems, but are not limited to the communication systems in the foregoing examples. In the following embodiments, a transmitting end and a receiving end are merely used as examples. For example, the receiving end may be a first apparatus, such as a terminal, a base station, a satellite, or a module or a chip included in the foregoing device. The transmitting end may be a second apparatus, such as a terminal, a base station, a satellite, or a module or a chip included in the foregoing device.

It should be noted that names of messages between network elements, names of parameters in the messages, or the like in the following embodiments of this application are merely examples, and there may be other names in implementation. This is not specifically limited in embodiments of this application.

It may be understood that, in embodiments of this application, the first apparatus or the second apparatus may perform some or all of steps in embodiments of this application. These steps are merely examples. In embodiments of this application, other steps or variations of various steps may be further performed. In addition, the steps may be performed in a sequence different from a sequence presented in embodiments of this application, and not all the steps in embodiments of this application may be necessarily performed.

As shown in FIG. 11, this application provides a communication method. The communication method may include the following steps.

1101: A second apparatus determines a first symbol.

The first symbol is a partial OFDM symbol newly defined in this application, and may be referred to as a partial OS. A name of the symbol is not specifically limited in this application.

The first symbol includes a first interval. In addition, the first symbol further includes a second interval or a third interval, or the first symbol further includes a second interval and a third interval. The first interval is used for implementing transition from downlink transmission to uplink transmission, and is used as a reserved resource or a guard period. The second interval is used for uplink transmission, and the third interval is used for downlink transmission. In other words, some resources in the first symbol are used for implementing transition from downlink transmission to uplink transmission, and the remaining resources may be used for transmitting wanted symbols, for example, carrying some uplink signals and/or downlink signals, to implement uplink and downlink transmission. Therefore, at least one GP symbol is no longer required as a guard period, and latency overheads of the guard period can be effectively reduced.

The first interval may include the following three meanings: (1) The first interval may be used for implementing transition from downlink transmission to uplink transmission, such as duration used by the receiving end for transition from downlink transmission to uplink transmission shown in FIG. 7. For example, in some low-latency implementation scenarios such as a factory scenario with low RTT, the RTT may be ignored. (2) The first interval may serve as a guard period, is not limited to a latency used for implementing transition from downlink transmission to uplink transmission, and may further include duration that is twice RTT or the like. (3) The first interval may serve as a reserved resource used for uplink and downlink transmission and for implementing a function of (1) or (2).

In an implementation, a starting position of the first interval may be a starting position of the first symbol, or an ending position of the first interval may be an ending position of the first symbol, or the starting position or the ending position of the first interval may be a middle position of the first symbol, or the starting position and/or the ending position of the first interval may be positions/a position other than the starting position and the ending position at the first symbol. In other words, the first interval may start from any position of the first symbol and end at any position of the first symbol.

FIG. 12 shows several types of first intervals. As shown in (a) in FIG. 12, for a front-positioned first interval, a starting position of the first interval may be a starting position of a first symbol, an ending position of the first interval may be any position other than the starting position and an ending position at the first symbol, and duration of the first interval is greater than 0 (s) and less than a length of the first symbol. For example, a length of the first interval may be a length of a half OFDM symbol. In this case, a 1^{st} half symbol of the first symbol may be the first interval, and a 2^{nd} half symbol may be used for carrying a wanted signal. For example, the 2^{nd} half symbol of the first symbol may be a second interval used for uplink transmission. It can be seen that the first symbol is for sending a partial uplink signal. Optionally, the partial uplink signal include a partial wanted signal, or the partial uplink signal includes a partial CP signal and a complete wanted signal.

In addition, as shown in (b) in FIG. 12, for a rear-positioned first interval, an ending position of the first interval may be an ending position of a first symbol, a starting position of the first interval may be any position other than a starting position and the ending position at the first symbol, and duration of the first interval is greater than 0 (s) and less than a length of the first symbol. For example, a length of the first interval may be a length of a half OFDM symbol. In this case, a 2^{nd} half symbol of the first symbol may be the first interval, and a 1^{st} half symbol may be used for carrying a wanted signal. For example, the first half symbol of the first symbol may be a third interval used for downlink transmission. Optionally, a partial downlink signal includes a complete CP signal and a partial wanted signal, or the partial downlink signal includes a partial wanted signal.

In addition, as shown in (c) in FIG. 12, for a mid-positioned first interval, both a starting position and an ending position of the first interval may be any position other than a starting position and an ending position at a first symbol, and duration of the first interval is greater than 0 (s) and less than a length of the first symbol. For example, a length of the first interval may be a length of a half OFDM symbol. In this case, a 1^{st} ¼ symbol of the first symbol may be a third interval used for downlink transmission, a middle ½ symbol is the first interval, and a last ¼ symbol of the first symbol may be a second interval used for uplink transmission. It can be seen that the first symbol is for sending a partial downlink signal. Optionally, the partial downlink signal includes a complete CP signal and a partial wanted signal; or the partial downlink signal includes a partial wanted signal. Optionally, a partial uplink signal includes a partial wanted signal, or, the partial uplink signal includes a partial CP signal and a complete wanted signal.

In an implementation, it may be pre-defined in a protocol that the first symbol includes the front-positioned first interval, or the mid-positioned first interval, or the rear-positioned first interval. Further, first indication information may indicate a specific format related to the front-positioned first interval or the mid-positioned first interval or the rear-positioned first interval. Alternatively, further optionally, the specific format related to the front-positioned first interval or the mid-positioned first interval or the rear-positioned first interval may be pre-defined in the protocol. The specific related format includes at least one of the following: a starting position of the first interval in the first symbol, duration corresponding to the first interval, a quantity of sampling points corresponding to the first interval, a proportion of the duration of the first interval in duration of the first symbol, duration of the second interval in the first symbol, a proportion of the duration of the second interval in the duration of the first symbol, duration of the third interval in the first symbol, or a proportion of the duration of the third interval in the duration of the first symbol. In the foregoing implementation, for a specific format of the first symbol that is pre-defined in the protocol, the first indication information does not need to be sent, and there are no indication overheads.

1102: The second apparatus sends first indication information to a first apparatus, where the first indication information indicates the first symbol.

That the second apparatus determines the first symbol may be that a format of the first symbol is determined. For example, the first symbol is of a type with the front-positioned, mid-positioned, or rear-positioned first interval. Alternatively, the format of the first symbol includes parameters such as the duration of the first interval included in the first symbol, and the starting position of the first interval included in the first symbol. After determining the format of the first symbol, the second apparatus may send the first indication information to the first apparatus, to indicate the format of the first symbol, such as the type of the first symbol and/or related parameters, to the first apparatus.

In an implementation, the first indication information may indicate at least one of the following: a starting position of the first interval in the first symbol, duration corresponding to the first interval, a quantity of sampling points corresponding to the first interval, a proportion of the duration of the first interval in duration of the first symbol, duration of the second interval in the first symbol, a proportion of the duration of the second interval in the duration of the first symbol, duration of the third interval in the first symbol, or a proportion of the duration of the third interval in the duration of the first symbol.

For example, it is pre-configured by the second apparatus and the first apparatus or specified in a protocol that a type of the first symbol is the front-positioned first interval, the mid-positioned first interval, or the rear-positioned first interval. In an example, for the type of the first symbol that is configured as the front-positioned first interval, the first indication information sent by the second apparatus to the first apparatus indicates the duration corresponding to the first interval, and the second apparatus may obtain the specific format of the first symbol based on the type that is of the first symbol and that is pre-configured or specified in the protocol and the duration corresponding to the first interval.

In another example, for the type of the first symbol that is defined as the front-positioned first interval, the mid-positioned first interval, or the rear-positioned first interval, the first indication information may include the starting position of the first interval and the duration corresponding to the first interval. For example, the duration corresponding to the first interval may be any proportion, such as ½ or ¼ of a length of the first symbol, and may be denoted as ½ OS or ¼ OS. In addition, the starting position of the first interval may be a starting position of the first symbol, a middle position of the first symbol, or a position at ¼ of the first symbol, and may be respectively denoted as a parameter 0, ½ OS, or ¼ OS. As shown in Table 2, the first indication information may include one of the following index values, and each index value is associated with one starting position of the first interval and one length of the first interval. The first indication information indicates parameters corresponding to the index, so as to indicate the format of the first symbol.

TABLE 2
Pre-defined/Configured first symbol parameters

| | Starting position of a | Length of a first |
|---|---|---|
| Index | first interval (OS) | interval (OS) |
| 00 | 0 | ½ |
| 01 | ½ | |
| 10 | ¼ | |

For example, with reference to Table 2 pre-defined/configured in the protocol, for the index included in the first indication information that is 00, it indicates that the first interval starts from the starting position of the first symbol, and the length of the first interval is ½ of the length of the first symbol. In this case, it may be determined based on the first indication information that the first symbol is in the format with the front-positioned first interval as described above. Similarly, for the index included in the first indication information that is 01, the index corresponds to the format with the rear-positioned first interval; or for the index included in the first indication information that is 10, the index corresponds to the format with the mid-positioned first interval.

In the foregoing examples, the parameters, such as the starting position of the first interval and the length of the first interval that are included in the first indication information, are in a unit of the length of the first symbol. In another implementation, the parameters, such as the starting position of the first interval and the length of the first interval that are included in the first indication information, may use millisecond (ms) as a unit of duration, or use a time unit, such as Ts or Tc above, as a unit of length.

For example, the first indication information may indicate at least one index in Table 3 below that is pre-defined/configured in the protocol. In Table 3, an SCS of 30 kHz and a normal CP are used as examples, and the first symbol includes (72+1024) Ts, where a length of the CP is 72 Ts, and a length of wanted information is 1024 Ts.

TABLE 3
Pre-defined/Configured first symbol parameters

| | Starting position of a | Length of a first |
|---|---|---|
| Index | first interval (Ts) | interval (Ts) |
| 00 | 72 | 512 |
| 01 | 584 | |
| 10 | 328 | |

For example, for the index included in the first indication information that is 00, it indicates that an ending position of the CP in the first symbol may be the starting position of the first interval, and the length of the first interval is ½ of a length of wanted information in the first symbol. In this case, the format of the first symbol may be determined based on the first indication information.

For example, for the index included in the first indication information that is 01, it indicates that the starting position of the first interval is a position at ½ of the length of the wanted information in the first symbol, and the length of the first interval is ½ of the length of the wanted information in the first symbol. In this case, the format of the first symbol may be determined based on the first indication information.

For example, for the index included in the first indication information that is 10, it indicates that the starting position of the first interval is a position at ¼ of the length of the wanted information in the first symbol, and the length of the first interval is ½ of the length of the wanted information in the first symbol. In this case, the format of the first symbol may be determined based on the first indication information.

It should be noted that, for a compressive sensing algorithm, in the foregoing embodiment, the starting position of the first interval may be a position at ½ OS or ¼ OS of the first symbol or may be any starting position of the first symbol; and the duration of the first interval may be ½, ¼, or the like of the first symbol, or may be any duration in the first symbol, and the any duration is less than or equal to the duration of the first symbol. For a frequency-domain zero-padding algorithm, the duration of the second interval and/or the duration of the third interval in the first symbol are/is to be greater than or equal to duration of one time-domain period. For example, frequency-domain zero-padding is performed between every two signals of a first frequency-domain signal [a1, a2, a3, a4], and an obtained second frequency-domain signal may be [a1, 0, a2, 0, a3, 0, a4, 0]. In this case, a second time-domain signal corresponding to the second frequency-domain signal is periodic. The second time-domain signal is two repetitions of a first time-domain signal corresponding to the first frequency-domain signal. One time-domain period represents duration of the first time-domain signal. Therefore, the second interval at least includes one time-domain period and/or the third interval at least includes one time-domain period.

In the foregoing implementations of configuring three types of the first symbol, a structure of the first symbol is simple, a quantity of formats of the first symbol pre-defined in a protocol or configured by using a higher layer is small, and overheads of the indication information are low.

In a possible implementation, one or more format index tables of the first symbols may be pre-configured or pre-defined, to include a plurality of format parameters of the first symbol. Then, one of index values is indicated using the first indication information, to indicate at least one format of the first symbol.

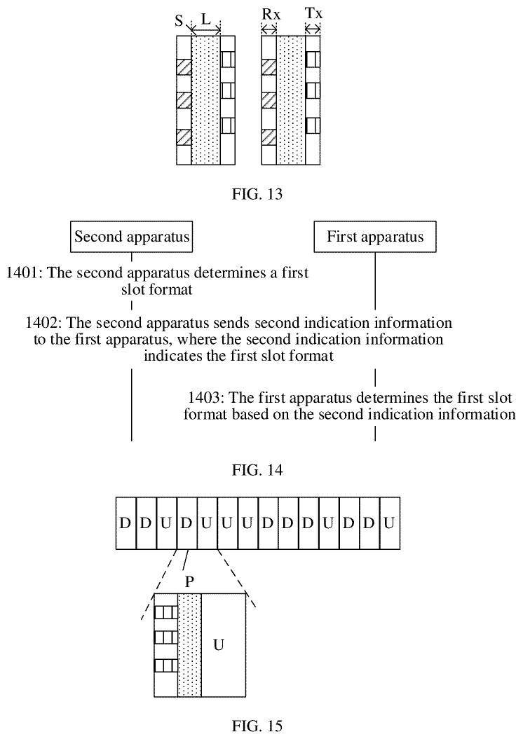

For example, each index value may correspond to a first position and first duration. The first position indicates a starting position of the first interval in the first symbol, and the first duration indicates duration of the first interval in the first symbol. As shown in FIG. 13, the first position is a starting position of a first interval, and is denoted as S; and the first duration is duration of the first interval, and is denoted as L.

For example, the first indication information may indicate at least one index value in Table 4. In Table 4, an SCS of 15 kHz and a normal CP are used as examples. The first symbol includes (144+2048) Ts, where a length of the CP is 144 Ts, and a length of wanted information is 2048 Ts.

TABLE 4
Pre-defined/Configured first symbol parameters

| Index value | S (Ts) | L (Ts) |
|---|---|---|
| 0 | 0 | 548 |
| 1 | 0 | 1096 |
| 2 | 0 | 1644 |
| 3 | 0 | 2192 |
| 4 | 548 | 548 |
| 5 | 548 | 1096 |
| 6 | 548 | 1644 |
| 7 | 1096 | 548 |
| 8 | 1096 | 1096 |
| 9 | 1644 | 548 |

It should be noted that the parameters in Table 4 are merely examples. S may be any position at the first symbol, such as a starting position of the first symbol, a position at ½ of the first symbol, a position at ¼ of the first symbol, or a position at ¾ of the first symbol, which respectively corresponds to S of 0, S of (144+2048)/2 Ts=1096 Ts, S of (144+2048)/4 Ts=548 Ts, or S of 3*(144+2048)/4 Ts=1644 Ts. Similarly, L may also be any length. Values of S and L are such that they satisfy a condition that S+L is less than or equal to a length of one first symbol.

In addition, for a plurality of index tables that are configured for the formats of the first symbol, a network device may configure one of the index tables for the first apparatus or the second apparatus by using higher layer signaling based on a service criterion. Alternatively, the second apparatus may configure one index table for the first apparatus, and indicate one index value in the index table to the first apparatus, to determine the format of the first symbol. The first symbol has flexibility in both format configuration and an indication manner.

Alternatively, in another implementation, each index value in the format index table of the first symbol may correspond to second duration and third duration. The second duration indicates duration of the third interval in the first symbol, and the third duration indicates duration of the second interval in the first symbol. As shown in FIG. 13, the second duration is duration of a downlink signal, and is denoted as Rx; and the third duration is duration of an uplink signal, and is denoted as Tx. For a receiving end, the second duration indicates time occupied for receiving a signal, and the third duration indicates time occupied for sending a signal.

For example, the first indication information may indicate at least one index value in Table 5. In Table 5, an SCS of 15 kHz and a normal CP are used as examples.

It should be noted that, in the following tables, values of Rx and Tx are such that they satisfy a condition that Rx+Tx is less than a length of one first symbol.

TABLE 5
Pre-defined/Configured first symbol parameters

| Index value | Rx (Ts) | Tx (Ts) |
|---|---|---|
| 0 | 0 | 548 |
| 1 | 0 | 1096 |
| 2 | 0 | 1644 |
| 3 | 548 | 0 |
| 4 | 548 | 548 |
| 5 | 548 | 1096 |
| 6 | 1096 | 548 |
| 7 | 1644 | 0 |

For example, the first indication information may indicate at least one index value in Table 6. In Table 6, an SCS of 60 kHz and a normal CP are used as examples. The first symbol includes (36+512) Ts, where a length of the CP is 36 Ts, and a length of wanted information is 512 Ts.

TABLE 6
Pre-defined/Configured first symbol parameters

| Index value | Rx (Ts) | Tx (Ts) |
|---|---|---|
| 0 | 0 | 137 |
| 1 | 0 | 274 |
| 2 | 0 | 411 |
| 3 | 137 | 0 |
| 4 | 137 | 137 |
| 5 | 137 | 274 |
| 6 | 274 | 137 |
| 7 | 274 | 274 |
| 8 | 411 | 0 |

In another example, the first indication information may indicate at least one index value in Table 7. In Table 7, an SCS of 60 kHz and a normal CP are used as examples. The first symbol includes (36+512) Ts, where a length of the CP is 36 Ts, and a length of wanted information is 512 Ts. A difference between Table 7 and the foregoing index tables lies in that the wanted information other than the CP in the first symbol is considered as a whole, and a starting position of the first interval and a length of the first interval are considered. For example, the length of the first interval may be configured as ½, ¼, or ¾ of 512 Ts of the wanted information and may be 256 Ts, 128 Ts, or 384 Ts, respectively.

TABLE 7
Pre-defined/Configured first symbol parameters

| Index value | Rx (Ts) | Tx (Ts) |
|---|---|---|
| 0 | 36 | 128 |
| 1 | 36 | 256 |
| 2 | 36 | 384 |
| 3 | 164 (36 +128) | 0 |
| 4 | 164 | 128 |
| 5 | 164 | 256 |
| 6 | 292 (36 + 256) | 0 |
| 7 | 292 | 128 |
| 8 | 420 (36 + 384) | 0 |
| 9 | 420 | 128 |

### Clean Copy Specification

It should be noted that the parameters in Table 5 to Table 7 are merely examples. Tx or Rx is not limited to the lengths in the foregoing tables, and may be any value that satisfies a condition. For example, a value of Rx+Tx is such that it satisfies a condition that Rx+Tx is less than a length of one first symbol.

In addition, in a possible implementation scenario, in response to duration of transition from receiving a signal to sending a signal being very short, the duration may be ignored. In other words, the length of the first interval included in the first symbol is considered as 0, and Rx+Tx may be equal to a length of one first symbol.

Correspondingly, the first apparatus may receive information from the second apparatus. Optionally, the method may further include the following steps.

1103: The first apparatus receives the first indication information, and determines the first symbol based on the first indication information.

In an implementation, the first indication information may be carried in higher layer signaling, or carried in physical layer signaling. For example, the first indication information may be carried in at least one of the following: a system information block (SIB) 1, a radio resource control (RRC) signal, downlink control information (DCI), sidelink control information (SCI), other physical layer signaling, or other higher layer signaling.

The format of the first symbol may be determined through multi-level indication. For example, the first apparatus may first receive an RRC signal from the network device or the second apparatus, to configure any index table of Table 2 to Table 7. Then, the first apparatus receives DCI or SCI from the second apparatus, to indicate at least one index value in the index table, so as to indicate the format of the first symbol.

In addition, in an implementation, the transmitting end and the receiving end may further determine, based on respective capability information, a format of a partial OS that satisfies the capability. In other words, the first apparatus may carry, onto the capability information, a parameter such as a type or a format of the first symbol supported by the first apparatus, and report the capability information to the second apparatus, so that the second apparatus may determine the format of the first symbol based on the received capability information.

Optionally, the method may further include the following steps:
1. The first apparatus sends the capability information to the second apparatus.
2. The second apparatus receives the capability information of the first apparatus.

The capability information indicates whether the first apparatus supports the first symbol and/or a type of the supported first symbol. Correspondingly, after successfully receiving the capability information of the first apparatus, the second apparatus may determine the first symbol based on the capability information.

In an implementation, the capability information may include at least one of the following: information about whether the first apparatus supports the first symbol, information about the type of the first symbol supported by the first apparatus, information about a transition period supported by the first apparatus, or information about a capability of the first apparatus for transition from downlink transmission to uplink transmission.

The information about the capability of the first apparatus from transition from downlink transmission to uplink transmission may be quantized to a specific value for representation. For example, the first apparatus may quantize the capability for transition from downlink transmission to uplink transmission to level 1, level 2, level 3, or the like. A larger level value indicates a lower capability of the first apparatus for transition from downlink transmission to uplink transmission, or indicates a higher latency of transition performed by the first apparatus from downlink transmission to uplink transmission. In this case, the duration of the first interval in the first symbol that is pre-defined by the second apparatus, or configured by using a higher layer, or indicated by physical layer signaling is longer. A smaller level value indicates a higher capability of the first apparatus for transition from downlink transmission to uplink transmission, or indicates a lower latency of transition performed by the first apparatus from downlink transmission to uplink transmission. In this case, the duration of the first interval in the first symbol that is pre-defined by the second apparatus, or configured by using a higher layer, or indicated by physical layer signaling is shorter.

Alternatively, in an implementation, the capability information of the first apparatus may be represented by the transition period. The transition period may refer to duration of a period during which the first apparatus undergoes one continuous uplink and downlink transmission transition. For example, one period is equal to time used for downlink transmission, time used for downlink-to-uplink transition, and time used for uplink transmission. For example, the transition period of the first apparatus is denoted as T. In this case, T=X/14 (slot), where X may be a positive integer, and X may be represented as a maximum quantity of transitions from downlink transmission to uplink transmission within one slot. Alternatively, the transition period may be expressed in time units, such as milliseconds or microseconds.

For example, the first apparatus may associate the quantized value of the capability for transition from downlink transmission to uplink transmission with the transition period. As shown in Table 8, the first apparatus may determine, based on information about a supported transition period, a corresponding quantized value of the capability for transition from downlink transmission to uplink transmission, and send determined capability information to the second apparatus. A smaller quantized level value of the capability indicates more flexible uplink-downlink transition of a slot format configurable by the first apparatus.

TABLE 8

| Quantized | | |
|---|---|---|
| level value | Capability | Transition period (slot) |
| Level 1 | High | 1/14, 2/14, 3/14, 4/14 |
| Level 2 | Relatively high | 5/14, 6/14, 7/14, 8/14, 9/14 |
| Level 3 | Relatively low | 10/14, 11/14, 12/14, 13/14, 1 |

In the foregoing implementation, the transmitting end and the receiving end for signal transmission can negotiate a supported OFDM format, and a symbol format can be flexibly configured based on the capability of the receiving end. In this way, the transmitting end determines a partial OFDM format supported by the receiving end (e.g., the foregoing format of the first symbol) and further determines a slot format, thereby achieving more flexible and reliable transmission.

In addition, it can be seen from the foregoing table that, by using the symbol format in embodiments of this application, a maximum of 14 uplink-downlink transitions can be implemented within one slot. In comparison with a case in which a maximum of 2 uplink-downlink transitions can be implemented within one slot, this application can effectively improve transmission flexibility, lower an uplink-downlink transition latency, and improve communication efficiency.

Based on the foregoing defined format of the first symbol, this application further provides a communication method for a transmitting end and a receiving end to determine a format of at least one slot including the first symbol, so as to use a partial symbol in specific information transmission and reduce latency overheads of a guard period. It can be seen that the foregoing embodiments of this application may be combined with the following embodiments. Based on an example implementation scenario, the receiving end may receive configuration information of the first symbol, such as first indication information. Before or after receiving the first indication information, the receiving end may further receive second indication information that indicates a first slot format including the first symbol. An implementation and an implementation sequence are not limited in embodiments of this application.

It should be noted that a slot format may refer to a combination of various symbols included in one slot and an arrangement order. In an application scenario of this application, in addition to the slot format, a mini-slot format or a frame format may be further determined. The following embodiments are described merely by using the slot format as an example and constitute no limitation thereto.

As shown in FIG. 14, the method may include the following steps.

1401: A second apparatus determines a first slot format.

The first slot format may include at least one first symbol. In this embodiment of this application, the first symbol may be denoted as a symbol P.

It can be learned from the foregoing embodiments that a type of a symbol type within one slot, one mini-slot, or one frame includes D (which may be identified as Rx for a terminal and is represented as a receive symbol), U (which may be identified as Tx for the terminal and is represented as a transmit symbol), F, and P. The symbol D and the symbol U belong to an OFDM OS, the symbol P belongs to a partial OS, and the symbol F may be considered as belonging to an OFDM OS or may be considered as belonging to a partial OS.

In the foregoing several symbols, a symbol that may be used for downlink transmission includes D, P, or F; and a symbol that may be used for uplink transmission includes U, P, or F. One symbol P may include a partial symbol used for uplink transmission (such as the foregoing second interval), or may include a partial symbol used for downlink transmission (such as the foregoing third interval), or may include both a partial symbol used for uplink transmission and a partial symbol used for downlink transmission (for example, includes the second interval and the third interval).

For example, an example in which one slot includes 14 symbols is used. Any one of the 14 symbols may be U, D, F, or P. A transmitting end may determine a type and an arrangement ranking of each symbol in the slot format based on a transmission criterion between the transmitting end and a receiving end.

1402: The second apparatus sends second indication information to a first apparatus, where the second indication information indicates the first slot format.

After determining the first slot format, the second apparatus may indicate the first slot format to the first apparatus by sending the second indication information.

1403: The first apparatus determines the first slot format based on the second indication information.

In an implementation, the second indication information may indicate position information of each symbol, and may include position information of the at least one first symbol. For example, an index table of a slot format may be configured between the first apparatus and the second apparatus, and one index value in the table is indicated based on the second indication information, and is used for corresponding to an arrangement format of a group of symbols within one slot. For example, Table 9 shows some possible slot formats.

TABLE 9
Slot index table

| | Symbols within a slot | | | | | | | | | | | | | |
|---|---|---|---|---|---|---|---|---|---|---|---|---|---|---|
| Index value | 0 | 1 | 2 | 3 | 4 | 5 | 6 | 7 | 8 | 9 | 10 | 11 | 12 | 13 |
| 0 | P | U | P | U | P | U | P | U | P | U | P | U | P | U |
| 1 | F | U | F | U | F | U | F | U | P | U | P | U | P | U |
| 2 | D | P | U | D | P | U | D | P | U | D | P | U | U | U |
| 3 | D | P | U | U | D | P | U | U | D | P | U | U | U | U |
| 4 | D | D | P | U | U | D | D | P | U | U | D | D | P | U |
| 5 | D | D | F | U | U | D | D | P | F | U | D | D | P | U |
| 6 | D | D | D | D | P | U | D | D | D | D | D | D | P | U |
| 7 | D | D | D | D | D | D | D | P | F | U | U | U | U | U |
| 8 | P | P | P | P | P | P | P | P | P | P | P | P | P | P |

In another implementation, it may be pre-configured or defined in a protocol that the first symbol may be a last symbol of a downlink channel, or the first symbol may be a 1^{st} symbol of an uplink channel.

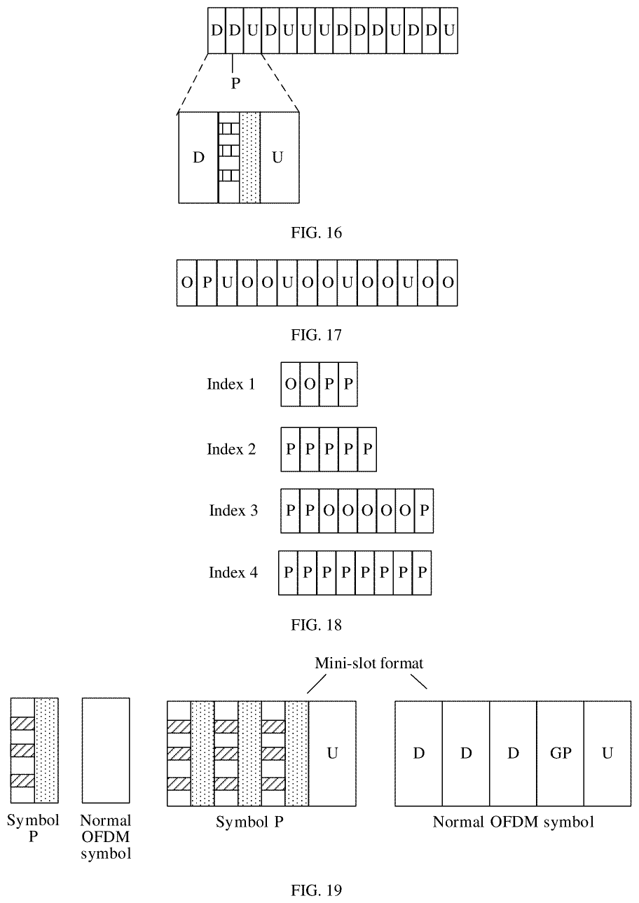

For example, as shown in FIG. 15, for the downlink channel that occupies one symbol, the symbol may be specified as the first symbol P. For the downlink channel that occupies more than one symbol, for example, occupies n symbols, a 1^{st} symbol to a (n−1)^{th} symbol are normal OFDM symbols, and a n^{th} symbol, such as a last symbol, may be the first symbol P. For example, as shown in FIG. 16, For the downlink channel that occupies 2 symbols, a 1^{st} symbol may be a symbol D, and a 2^{nd} symbol may be the first symbol P.

Similarly, it is specified in the protocol that the first symbol is the 1^{st} symbol of the uplink channel.

For example, for the uplink channel that occupies one symbol, the symbol may be specified as the first symbol P. For the uplink channel that occupies more than one symbol, for example, occupies n symbols, a 1^{st} symbol may be the first symbol P, and a 2^{nd} symbol to a n^{th} symbol are normal OFDM symbols.

In another implementation, the second indication information may indicate a sequence number of the at least one first symbol in the first slot format. The sequence number may refer to position information of the first symbol in the first slot format.

For example, the second indication information indicates the position information of the first symbol. For the receiving end, such as the first apparatus, that determines that a received signal includes the second indication information, the receiving end may determine that the slot format includes the first symbol. For the receiving end that determines that the received signal does not include the second indication information, the receiving end may determine that the slot format does not include the first symbol and includes only a normal symbol type. Further, the first apparatus may determine position information of each first symbol based on the second indication information. For example, in a first slot format shown in FIG. 17, such a slot includes one first symbol P, with a sequence number of 1, indicating that the symbol P is located at a 2^{nd} symbol position in the slot (a sequence number of a 1^{st} symbol is 0).

In the foregoing indication manner, for a quantity of first symbols included in the slot format that is small, for example, a quantity of first symbols included in one slot is 1, 2, or the like, a specific indication of the first symbol in the determined slot format may be implemented with low signaling overheads in a flexible indication manner.

In addition, in an implementation, the second indication information may indicate information about the first symbol included in an uplink transmission symbol, a downlink transmission symbol, a flexible symbol, a frame structure, or a mini-slot. The second indication information may indicate whether the symbol for uplink transmission, the symbol for downlink transmission, the flexible symbol, the frame structure, or the mini-slot includes the first symbol. Further optionally, the second indication information may indicate a quantity of included first symbols and/or position information of the first symbol.

In an implementation, the slot format may alternatively be indicated in the following manner: First, rough indication is performed based on an existing slot format indication manner, for example, a second slot format is indicated; and then the second indication information is further indicated. For example, the second indication information may indicate a symbol or symbols in the second slot format that are the first symbol/symbols, so that a specific slot format is determined through hierarchical indication.

The method includes: Before receiving the second indication information, the first apparatus may further receive third indication information, where the third indication information indicates the second slot format, and the second slot format includes at least one of an uplink symbol, a downlink symbol, or a flexible symbol. For example, one second slot format may be first configured for the first apparatus via higher layer signaling; and then the second indication information indicates, to the first apparatus, that at least one symbol included in the second slot format may be the first symbol.

In this case, the second indication information may include a sequence number of the at least one symbol in the second slot format, and the sequence number indicates a sequence number of the first symbol included in the first slot format.

For example, an index table for symbols of a specific transmission type may be configured, and the second indication information indicates a symbol type of each symbol corresponding to a different quantity of symbols for this transmission type, indicating whether the symbol is configured as a normal OS symbol or configured as the first symbol P in this embodiment of this application.

For example, downlink transmission is used as an example. Table 10 shows some possible examples. A normal OS symbol may be denoted as O, and indicates an existing symbol U, D, or F. For downlink transmission, a normal symbol that may be configured may be the symbol D or the symbol F.

TABLE 10

| | Quantity of symbols used | Indicated |
|---|---|---|
| Index | for downlink transmission | symbol |
| value | within a slot | type |
| 0 | 1 | O |
| 1 | 1 | P |
| 2 | 2 | O, O |
| 3 | 2 | O, P |
| 4 | 2 | P, P |
| 5 | 3 | P, P, P |
| 6 | 3 | O, O, O |
| 7 | 3 | O, O, P |

. . .

Similarly, for uplink transmission, an index table for uplink transmission symbols may also be configured to indicate a symbol type corresponding to a different quantity of symbols in uplink transmission, indicating whether the symbol is configured as a normal OS symbol or the first symbol P.

For example, FIG. 18 shows some possible examples. A normal OS symbol may be denoted as O, and indicates an existing symbol U, D, or F. Index 1 corresponds to Tx with 4 symbols, including 2 symbols P. Index 2 corresponds to Tx with 5 symbols, including 5 symbols P. Index 3 corresponds to Tx with 8 symbols, including 3 symbols P. Index 4 corresponds to Tx with 8 symbols, including 8 symbols P.

Optionally, the second indication information may indicate whether a normal OFDM symbol or the first symbol P in embodiments of this application is configured in one determined OFDM symbol within a mini-slot, a mini-slot, a slot, a downlink channel, a symbol F, or a frame structure.

For example, as shown in FIG. 19, for indication of the second indication information that is for a mini-slot, it may be determined, based on the second indication information, that the mini-slot is configured with a symbol P, or configured with a normal OFDM symbol.

In an implementation, the second indication information may be carried in at least one of the following: an SIB1, an RRC signal, DCI, SCI, a slot format indicator (SFI), other physical layer signaling, or other higher layer signaling. For example, a slot format may be indicated through multi-level indication. For example, the second apparatus first sends, to the first apparatus, an RRC signal that carries a configured slot format index table; and then the second apparatus sends DCI to the first apparatus, to indicate one index value in the table, so that the first apparatus determines the first slot format.

To improve transmission reliability, a slot format may be flexibly configured based on a capability of the receiving end in a manner of negotiation between the receiving end and the transmitting end. As described above, in a possible implementation, the method may further include the following steps.
1. The first apparatus sends capability information to the second apparatus.
2. The second apparatus receives the capability information of the first apparatus.

The capability information indicates whether the first apparatus supports the first symbol and/or a type of the supported first symbol. Correspondingly, after successfully receiving the capability information of the first apparatus, the second apparatus may determine the first slot format based on the capability information. Similarly, for a specific indication manner of the capability information, refer to the foregoing content. Details are not described herein again.

In the foregoing implementations of this application, the transmitting end and the receiving end may determine the used first slot format based on the second indication information, and may determine a specific type and format of the first symbol in the first slot format based on the first indication information in the foregoing embodiments. In this way, the transmitting end and the receiving end can flexibly configure and indicate a transmission resource, thereby improving transmission efficiency.

It should be noted that the foregoing several implementations provided in this application may be separately used, or some implementations may be used in combination. For example, execution steps of each implementation are applied to a same procedure. Details are not described in this application one by one.

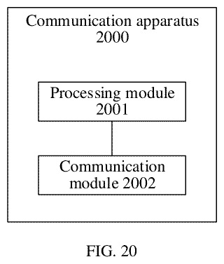

In addition, this application further provides a communication apparatus. As shown in FIG. 20, a communication apparatus 2000 may include a processing module 2001 and a communication module 2002.

The communication apparatus 2000 may implement functions of the transmitting end or the receiving end in the possible implementation in FIG. 11 or FIG. 14. For details, refer to detailed descriptions in the foregoing method examples. Details are not described herein again.

For example, the communication apparatus implements the function of the receiving end, such as the first apparatus, in the possible implementation in FIG. 11 or FIG. 14. The function may be implemented by hardware, or may be implemented by hardware executing corresponding software. The hardware or the software includes one or more modules corresponding to the foregoing function.

For example, in the implementation shown in FIG. 11 or FIG. 14, for the communication apparatus 2000 that is configured to implement the function of the second apparatus, the processing module 2001 may be configured to determine a first symbol or a first slot format. The communication module 2002 may be configured to send first indication information or second indication information to the first apparatus.

For example, in the implementation shown in FIG. 11 or FIG. 14, for the communication apparatus 2000 that is configured to implement the function of the first apparatus, the communication module 2002 is configured to receive first indication information or second indication information, to determine a first symbol or a first slot format.

For an example execution process and embodiments of the communication apparatus, refer to the steps performed by the transmitting end or the receiving end in the foregoing method embodiments and related descriptions. For a to-be-solved technical problem and an achieved technical effect, refer to the content in the foregoing embodiments. Details are not described herein again.

It may be understood that, with reference to FIG. 20, the network elements in embodiments of this application may employ a composition structure shown in FIG. 20 or include components shown in FIG. 20. FIG. 20 is a diagram of a structure of a communication apparatus 2000 according to an embodiment of this application. When the communication apparatus 2000 has the function of the first apparatus or the second apparatus in embodiments of this application, the communication apparatus 2000 may be a chip or a system-on-a-chip in the first apparatus or the second apparatus.

In embodiments of this application, a chip system may include a chip, or may include a chip and another discrete component.

With reference to FIG. 6, for example, a function/implementation process of the processing module 2001 in FIG. 20 may be implemented by the processor 601 in FIG. 6 by invoking computer program instructions stored in the memory 603. For example, a function/implementation process of the communication module 2002 in FIG. 20 may be implemented through the communication interface 604 in FIG. 6.

When the communication apparatus 2000 is an electronic device, the communication module 2002 may be a transceiver and may include an antenna, a radio frequency circuit, and the like, and the processing module 2001 may be a processor such as a baseband chip. When the apparatus is a component having the function of the first apparatus or the second apparatus in the foregoing embodiments, the communication module 2002 may be a radio-frequency unit, and the processing module 2001 may be a processor. When the apparatus is a chip system, the communication module 2002 may be an input interface and/or an output interface of the chip system, and the processing module 2001 may be a processor of the chip system such as a central processing unit (CPU).

In some implementations, the processor 601 in FIG. 6 may invoke computer-executable instructions stored in the memory 603, to cause the apparatus 600 to perform operations implemented by the first apparatus or the second apparatus in the foregoing method embodiments, thereby implementing the method in the foregoing possible implementations of this application.

In this embodiment, the communication apparatus is presented in a form of functional modules obtained through division in an integrated manner. The “module” herein may refer to a specific circuit, a processor for executing one or more software or firmware programs and a memory, an integrated logic circuit, and/or another device that can provide the foregoing functions. In a simple embodiment, a person skilled in the art may figure out that the communication apparatus may be in the form shown in FIG. 6.

In an example embodiment, a non-transitory computer-readable storage medium or a computer program product that includes instructions is further provided. The instructions may be executed by the processor 601 of the communication apparatus 600 to implement the method in the foregoing embodiments. Therefore, for a technical effect that can be achieved by the non-transitory computer-readable storage medium or the computer program product, refer to the foregoing method embodiments. Details are not described herein again.

This application further provides a computer program product. The computer program product includes instructions, and the instructions, when executed, cause a computer to perform operations of a terminal device or a network device that corresponds to the foregoing method.

An embodiment of this application further provides a system on a chip. The system on a chip includes a processing unit and a communication unit. The processing unit may be, for example, a processor, and the communication unit may be, for example, an input/output interface, a pin, a circuit, or the like. The processing unit may execute computer instructions, to cause a communication apparatus in which the chip is used to perform the operations of the terminal device and the network device in the method provided in the foregoing embodiments of this application.

Optionally, any communication apparatus provided in embodiments of this application may include the system on a chip.

Optionally, the computer instructions are stored in a storage unit.

An embodiment of this application further provides a communication system. The communication system may include any one of the first apparatus and the second apparatus in the foregoing implementations.

All or some of the foregoing embodiments may be implemented by using software, hardware, firmware, or any combination thereof. When a software program is used to implement embodiments, all or some embodiments may be implemented in a form of a computer program product. The computer program product includes one or more computer instructions. When the computer program instructions are loaded and executed on a computer, all or some of the procedures or functions according to embodiments of this application are generated. The computer may be a general-purpose computer, a dedicated computer, a computer network, or another programmable apparatus.

The protocol described in this application may be a communication protocol or a specification, such as a 3rd Generation Partnership Project (3GPP) communication protocol.

It can be understood that in embodiments of this application, the terminal and/or the network device may perform some or all of the steps in embodiments of this application. These steps or operations are merely examples. In embodiments of this application, other operations or variations of various operations may be further performed. In addition, the steps may be performed in a sequence different from a sequence presented in embodiments of this application, and not all the operations in embodiments of this application may be necessarily performed.

In this application, “at least one” means one or more, and “a plurality of” means two or more. “And/or” describes an association relationship between associated objects, and represents that three relationships may exist. For example, A and/or B may represent the following cases: Only A exists, both A and B exist, and only B exists, where A and B may be singular or plural. In text descriptions of this application, the character “/” generally represents an “or” relationship between associated objects.

It should be noted that in this application, the terms such as “example” or “for example” are used to represent giving an example, an illustration, or a description. Any embodiment or design scheme described as an “example” or “for example” in this application should not be explained as being more preferred or having more advantages than another embodiment or design scheme. Use of the word such as “example” or “for example” is intended to present a relative concept in a manner for ease of understanding.

In embodiments of this application, unless otherwise stated or there is a logic conflict, terms and/or descriptions in different embodiments are consistent and may be mutually referenced, and technical features in different embodiments may be combined into a new embodiment based on an internal logical relationship thereof.

The foregoing descriptions are merely example implementations of this application, but are not intended to limit the scope of protection of this application. Any variation or replacement readily figured out by a person skilled in the art within the technical scope disclosed in this application shall fall within the scope of protection of this application. Therefore, the scope of protection of this application shall be subject to the scope of protection of the claims.

1. A communication method, wherein the method comprises:
determining a first symbol, wherein the first symbol comprises a first interval and a second interval, or comprises a first interval and a third interval, or comprises a first interval, a second interval, and a third interval, the first interval is used for transition from downlink transmission to uplink transmission and serves as a reserved resource or a guard period, the second interval is used for uplink transmission, and the third interval is used for downlink transmission; and
sending first indication information, wherein the first indication information indicates the first symbol.

2. The method according to claim 1, wherein the first indication information indicates at least one of the following:
a starting position of the first interval in the first symbol, duration corresponding to the first interval, a proportion of the duration of the first interval in duration of the first symbol, duration of the second interval in the first symbol, a proportion of the duration of the second interval in the duration of the first symbol, duration of the third interval in the first symbol, or a proportion of the duration of the third interval in the duration of the first symbol.

3. The method according to claim 2, wherein the first symbol is pre-configured as follows: the starting position of the first interval is a starting position of the first symbol, or an ending position of the first interval is an ending position of the first symbol, or the starting position or the ending position of the first interval is a middle position of the first symbol, or the starting position of the first interval is a position other than the starting position and the ending position at the first symbol, or the ending position of the first interval is a position other than the starting position and the ending position at the first symbol, or the starting position and the ending position of the first interval are positions other than the starting position and the ending position at the first symbol.

4. The method according to claim 1, wherein the first indication information comprises a first index value, and the first index value corresponds to a first position and first duration, wherein
the first position indicates a starting position of the first interval in the first symbol, and the first duration indicates duration of the first interval in the first symbol; or
the first indication information comprises a second index value, and the second index value corresponds to second duration and third duration, wherein
the second duration indicates duration of the third interval in the first symbol, and the third duration indicates duration of the second interval in the first symbol.

5. The method according to claim 1, wherein the first indication information is carried in at least one of the following: a system information block (SIB1), a radio resource control RRC signal, downlink control information DCI, or sidelink control information (SCI).

6. The method according to claim 1, wherein the method further comprises:
receiving capability information of a first apparatus, wherein the capability information indicates at least one of the followings:
whether the first apparatus supports the first symbol, or a type of the supported first symbol.

7. The method according to claim 6, wherein the capability information comprises at least one of the following: information about whether the first apparatus supports the first symbol, information about the type of the first symbol supported by the first apparatus, information about a transition period supported by the first apparatus, or information about a capability of the first apparatus for transition from receiving a downlink signal to sending an uplink signal.

8. A communication method, wherein the method comprises:
determining a first slot format, wherein the first slot format comprises at least one first symbol, the first symbol comprises a first interval and a second interval, or comprises a first interval and a third interval, or comprises a first interval, a second interval, and a third interval, the first interval is used for transition from downlink transmission to uplink transmission and serves as a reserved resource or a guard period, the second interval is used for uplink transmission, and the third interval is used for downlink transmission; and
sending second indication information indicating the first slot format.

9. The method according to claim 8, wherein the second indication information indicates position information of the at least one first symbol.

10. The method according to claim 8, wherein the first symbol is a last symbol of a downlink channel, or the first symbol is a 1^{st} symbol of an uplink channel.

11. The method according to claim 9, wherein the second indication information indicates a sequence number of the at least one first symbol in the first slot format.

12. The method according to claim 8, wherein the second indication information indicates information about the first symbol comprised in an uplink transmission symbol, a downlink transmission symbol, a flexible symbol, a frame structure, or a mini-slot.

13. The method according to claim 8, wherein the second indication information is carried in at least one of the following: a system information block SIB1, a radio resource control RRC signal, downlink control information DCI, side control information SCI, or a slot format indicator SFI.

14. The method according to claim 8, wherein the method further comprises:
receiving/sending capability information of a first apparatus, wherein the capability information indicates at least one of the followings:
whether the first apparatus supports the first symbol, or a type of the supported first symbol.

15. The method according to claim 13, wherein the capability information comprises at least one of the following: information about whether the first apparatus supports the first symbol, information about the type of the first symbol supported by the first apparatus, information about a transition period supported by the first apparatus, or information about a capability of the first apparatus for transition from receiving a downlink signal to sending an uplink signal.

16. A communication apparatus, comprising a processor, the processor is configured to, when executing the programming instructions, enable the communication apparatus to: determining a first symbol, wherein the first symbol comprises a first interval and a second interval, or comprises a first interval and a third interval, or comprises a first interval, a second interval, and a third interval, the first interval is used for transition from downlink transmission to uplink transmission and serves as a reserved resource or a guard period, the second interval is used for uplink transmission, and the third interval is used for downlink transmission; and
sending first indication information, wherein the first indication information indicates the first symbol.

17. The apparatus according to claim 16, wherein the first indication information indicates at least one of the following:
a starting position of the first interval in the first symbol, duration corresponding to the first interval, a proportion of the duration of the first interval in duration of the first symbol, duration of the second interval in the first symbol, a proportion of the duration of the second interval in the duration of the first symbol, duration of the third interval in the first symbol, or a proportion of the duration of the third interval in the duration of the first symbol.

18. The apparatus according to claim 17, wherein the first symbol is pre-configured as follows: the starting position of the first interval is a starting position of the first symbol, or an ending position of the first interval is an ending position of the first symbol, or the starting position or the ending position of the first interval is a middle position of the first symbol, or the starting position of the first interval is a position other than the starting position and the ending position at the first symbol, or the ending position of the first interval is a position other than the starting position and the ending position at the first symbol, or the starting position and the ending position of the first interval are positions other than the starting position and the ending position at the first symbol.

19. The apparatus according to claim 16, wherein the first indication information comprises a first index value, and the first index value corresponds to a first position and first duration, wherein
the first position indicates a starting position of the first interval in the first symbol, and the first duration indicates duration of the first interval in the first symbol; or
the first indication information comprises a second index value, and the second index value corresponds to second duration and third duration, wherein
the second duration indicates duration of the third interval in the first symbol, and the third duration indicates duration of the second interval in the first symbol.

20. The apparatus according to claim 16, wherein the first indication information is carried in at least one of the following: a system information block (SIB1), a radio resource control RRC signal, downlink control information DCI, or sidelink control information (SCI).
